(19) United States
(12) Patent Application Publication
(10) Pub. No.: US 2006/0220400 A1
(43) Pub. Date: Oct. 5, 2006

(54) Vehicle Panel Shielding Apparatus

(76) Inventor: Daniel L. Diamond, Brookeville, MD (US)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 11/277,603

(22) Filed: Mar. 27, 2006

Related U.S. Application Data
(60) Provisional application No. 60/665,839, filed on Mar. 29, 2005.

(51) Int. Cl. B60R 19/42

(52) U.S. Cl. 293/126

(57) ABSTRACT

An apparatus for temporarily shielding at least one vehicle panel against impact or abrasion, or both, includes an impact absorber and a non-abrasive cover positioned between the impact absorber and the at least one vehicle panel. The impact absorber may be mounted and positioned on the at least one vehicle panel by using straps to suspend the impact absorber from the at least one vehicle panel, a mirror, roof rack, or the like or by using a magnet or magnets affixed to or within the impact absorber or cover, or a combination thereof.

This application claims the benefit of U.S. Provisional Patent Application No. 60/665,839, filed Mar. 29, 2005, which is incorporated herein by reference.

### BACKGROUND OF THE INVENTION

1. Filed of the Invention

The present invention relates to an apparatus for shielding a vehicle panel or panels from impact or abrasion, or both, More particularly, the present invention relates to an apparatus which may be removable and may be stored within a vehicle and which may be temporarily mounted to or suspended from the vehicle to shield the vehicle panel or panels from impact or abrasion, or both.

2. Description of Related Art

Each day, thousands of vehicles parked in supermarket or mall parking lots suffer impacts or abrasions, or both, in door and other vehicle panels when persons entering or exiting adjacent, parked vehicles open doors into those vehicles. Such impacts or abrasions may cause dins, chips, scrapes, nicks, scratches, dents, or other damage to the panels or to the finishes applied to the panels of those vehicles. Similar impacts or abrasions may occur when shopping carts, strollers, and the like, strike parked vehicles. Apart from the annoyance that such impacts or abrasions cause the vehicle owner, repairing such impacts or abrasions may be expensive, Moreover, the failure to repair them may result in rust attacking the damaged vehicle panels and in a reduction in the vehicle's value and attractiveness. As a result, some vehicles have done away with metal, vehicle panels entirely, replacing them with panels made from polymers.

In recent years, many vehicles have been designed to include door guards and other vehicle body moldings intended to reduce the number and severity of such impacts or abrasions. Nevertheless, such guards and moldings may not be installed or may be only optionally installed on certain vehicles, especially, higher priced and lower priced vehicles. Moreover, such guards and moldings often detract from the overall appearance and design lines of the vehicle and may significantly increase the cost of vehicle manufacture and vehicle weight. Further, replacing such guards and moldings may add to repair costs, and differences in the rates at which the finishes of metal and plastic parts fade due to exposure to sun and weather also may detract from overall vehicle appearance.

### SUMMARY OF THE INVENTION

A need has arisen for a apparatus, which is relatively lightweight and readily mounted on and removed from a vehicle to reduce or eliminate the effects of vehicle doors or other objects impacting, slamming e.g., into the metal panels of vehicles, such as cars, trucks, minivans, recreational vehicles, or other wheeled and tracked means for land transportation. A study of vehicles in public parking facilities revealed that greater than about 85% of the significant damage to vehicle panels occurred within a section of the side of a vehicle about 127 cm (about 50 inches) long and about 25.4 cm to about 40.6 cm (about 10 inches to about 16 inches) wide. This damage varied between relatively shallow scratches to relatively deep dents. It is a feature of this apparatus that it shields vehicle panels against impacts or abrasions, or both, in commonly exposed areas that are susceptible to damage. A further need has arisen for such an apparatus which also may be used to shield vehicle bumpers from impacts or abrasions, or both. A similar study of vehicle bumpers revealed that an area spanning about 127 cm (about 50 inches) was most likely to come into contact with other vehicles while parallel parked.

Although a full-size, four door vehicle may make most frequent contact with an adjacent vehicle over an area of less than about 127 cm (about 50 inches) on an adjacent vehicle, it is desirable to shield a larger area. Because vehicles may not be precisely aligned when they park along side each other, a larger area may be shielded to compensate for such imprecise alignment. An apparatus spanning about 127 cm (about 50 inches) allows vehicles of varying sizes and door dimensions to be substantially shielded against damage from other vehicles of varying sizes and door dimensions.

In an embodiment of this invention an apparatus for temporarily shielding at least one vehicle panel against tact or abrasion, comprises an impact absorber, a non-abrasive cover disposed between the impact absorber and the at least one vehicle panel, and means for mounting the impact absorber to the at least one vehicle panel. The at least one vehicle panel may be selected from the group consisting of a door panel, a side panel, a fender, a trunk, a hood, a bumper, and combinations thereof

In various embodiments, the impact absorber may comprise a plurality of impact absorbing elements or a plurality of layers of impact absorbing elements, or both. The impact absorber also may comprise a plurality of compartments, into each of which at least one impact absorbing element may be inserted to increase a width or a coverage area, or both, of the impact absorber. Moreover, the impact absorber may be circular, trapezoidal rectangular, or another geometric shape, as appropriate to the area of the panel or panels to be shielded.

The impact absorber may be manufactured from any material which may absorb the force of an impact or an abrasion, or both. Suitable materials may include of a variety of polymers, fabrics, or organic materials, such as Styrofoam or foam rubber. Preferably, the impact absorber material is resilient or impact resistant. Other suitable materials may have some combination of the following qualities: superior tensile strength at reduced weight, increased toughness, superior dimensional stability, minimal or reduced thermal shrinkage, and enhanced cut resistance.

In another embodiment, the cover may enclose the impact absorber. The cover may be made or at least the exposed surfaces of the cover opposite the vehicle panel may be made of a water resistant material or fabric. Alternatively, the cover may be a polymer coating applied as a spray or film or the like over a surface or surfaces of the impact absorber

The means for mounting may take a variety of forms in different embodiments of the invention, but each of these means performs similar functions of mounting or positioning or mounting and positioning the impact absorber or a portion of the impact absorber on at least one vehicle panel. For example, the means for mounting may comprise at least one strap for securing the impact absorber to the vehicle. Further, the at least one strap may comprise a device for adjusting the length of the at least one strap. The at least one strap also may comprise a clasp, a first portion, and a second portion, whereby the clasp is configured to separate the second portion from the first portion. In addition, the at least one strap farther may comprise a hook, an eyelet, a ring, a hanger, or the like affixed to an end of each of the at least one strap or to an end of each of the second portion of the at least one strap, whereby the at least one strap is configured to be secured to the vehicle. Further, the means for mounting may comprise at least one eyelet formed through the second portion of the strap and a vehicle mounted hook, such as a suction locked hook, affixed to the vehicle, wherein the at least one eyelet may be configured to receive the hook.

Alternatively or in addition to the at least one strap, in an embodiment of the invention, the means for mounting may comprise at least one magnet. Such a magnet or magnets may be affixed to a surface of the impact absorber facing the at least one vehicle panel or may be disposed within the impact absorber. In yet another embodiment, the at least one magnet may be affixed to or within the cover. In still another embodiment, at least one magnet may be affixed to the means for mounting, whereby the means for mounting may be secured to the roof or other portions of the vehicle. For example, if the means for mounting comprises at least one strap, at least one magnet may be affixed to the at least one strap, e.g., to a second portion of the at least one strap, In addition, the means for mounting may comprise magnets affixed both to the impact absorber and to the means for mounting.

In still yet another embodiment, the invention may be a kit for temporarily shielding at least one vehicle panel against impact or abrasion. Such a kit may comprise an impact absorber, a non-abrasive cover disposed between the impact absorber and the at least one vehicle panel, and means for mounting the impact absorber to the at least one vehicle panel wherein the means for mounting comprises at least one strap comprising a clasp, a first portion for positioning the impact absorber, and a plurality of interchangeable second portions for attaching the second portions to the vehicle. The at least one strap farther may comprise a device for adjusting a length of the at least one strap. Further, the plurality of interchangeable second portions may comprise a variety of securing devices and combinations of securing devices. For example, a first securing device of the plurality of interchangeable second portions may comprise a hook affixed to an end of the fist securing device, whereby the first securing device is configured to be secured to the vehicle; a second securing device of the plurality of interchangeable second portions may comprise an eyelet affixed to an end of the second securing device, whereby the second securing device is configured to be secured to the vehicle; a third securing device of the plurality of interchangeable second portions may comprise a hanger affixed to an end of the third securing device, whereby the third securing device is configured to be secured to the vehicle; a fourth securing device of the plurality of interchangeable second portions may comprise at least one eyelet formed through the second portion and a vehicle mounted hook, such as a suction locked hook, affixed to the vehicle, wherein the at least one eyelet may be configured to receive the hook.

Other objects, features, and advantages will be apparent to those of ordinary skill in the relevant art in view of the following detailed description of preferred embodiments and the accompanying drawings.

### BRIEF DESCRIPTION OF THE DRAWINGS

Embodiments of the invention now are described with reference to the accompanying figures, which are given by way of example only, and are, not intended to limit the scope of the present invention. The breaks in the straps depicted in FIGS. 3 and 6-10 are intended to indicate that the straps may be of varying size. Similarly, the break in the impact absorber of FIG. 11 is indicates that the impact absorber may be of varying size.

FIG. 1 depicts an embodiment of the apparatus mounted by two mounting straps to an automobile.

FIG. 2 depicts an adjusting device suitable for use on a mounting strap.

FIG. 3 depicts means for mounting comprising a clasp disposed between first portion of the strap connecting to the impact absorber and a second portion of the strap comprising a ring.

FIG. 4 depicts a connecting or male portion of a clasp that may be employed to add alternate second portions of a strap and to permit use of the apparatus with different vehicles.

FIG. 5 depicts a receiving or female portion of the clasp that may be employed to connect alternate second portions of a strap and to permit use of the apparatus with different vehicles.

FIG. 6 depicts a hook suitable for securing a strap to an eyelet or mounting ring in a truck bed and a second portion of a strap including a male portion of a clasp, as depicted in FIG. 4.

FIG. 7 depicts an eyelet suitable for securing a strap to a hook or handle, such as a clothes hanger, inside the sliding door of a minivan and a second portion of a strap including a male portion of a clasp, as depicted in FIG. 4.

FIG. 8 depicts a rotatably mounted hanger suitable for securing a strap to a roof rack, e.g., a carrier or luggage rack, of a minivan, sport utility vehicle (SUV), or the like and a second portion of a strap including a male portion of a cl, as depicted in FIG. 4.

FIG. 9A depicts a substantially square magnet affixed to a strap coring off a central portion of the magnet, for use with certain vehicles including panel van or panel truck models, which may not have a back door or roof rack from which to mount the apparatus, and FIG. 9B depicts a substantially cylindrical magnet housing with a connecting strap coming off the upper edge for use with certain vehicles including panel van or panel truck models, which may not have a back door or roof rack from which to mount the apparatus. Each depicted embodiment also comprises a second portion of a strap including a male portion of a clasp, as depicted in FIG. 4.

FIG. 10 depicts a loop for securing the second portion to a vehicle rear view or side mirror or a door handle or the like, and a second portion of a strap including a male portion of a clasp, as depicted in FIG. 4.

FIG. 11 depicts another embodiment of the apparatus on which means for mounting comprises a first portion and a second portion. The first portion is fixedly attached to the impact absorber, and the second portion is attached removably and adjustable to the first portion. The second portion comprises a plurality of hook receiving holes, e.g., eyelets, formed therein for receiving a hook attached to the vehicle.

FIGS. 12A and 12B depict a suction-locked hook suitable for temporary attachment to the vehicle to engage the hook receiving holes of the embodiment of the apparatus depicted in FIG. 11.

### DESCRIPTION OF PREFERRED EMBODIMENTS

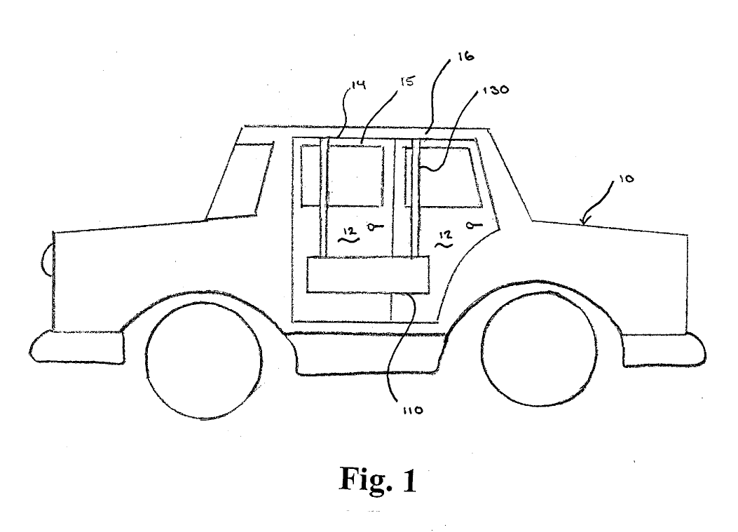

A description now is given of the embodiments depicted in FIG. 1-12B. FIG. 1 depicts an embodiment of the apparatus mounted by two mounting straps 130 to an automobile 10. A main body of the apparatus may comprise an impact absorber 110 made of a rubber or rubber composite or other polymer, which may or may not include other material fillers. The apparatus may be mounted to a vehicle via means for mounting which may comprise at least one strap or at least one magnet or combinations thereof Suitable straps 130 may include an interchangeable connecting mechanisms e.g., clasps, to facilitate selecting a mounting device, such as a ring, hook, eyelet, hanger, loop, magnet, or the like for mounting of the apparatus to the various makes and models vehicles, which currently are or may later come onto the market.

The apparatus may also include a cover, preferably, a non-abrasive cover, disposed between the impact absorber and at least one vehicle panel. The apparatus may be about 127 cm (about 50 inches) wide and about 25.4 (about 10 inches) to about 40.6 cm (about 16 inches) high, and preferably about 25.4 (about 10 inches) to about 30.5 cm (about 12 inches) high. In selecting the material for the inner core of the impact absorber, a material was selected which has sufficient compressibility to absorb the impact of a violently slammed vehicle door, which is at least water resistant and preferably, water repellant, and which is not adversely affected by prolonged exposure to extremes of heat and cold. While a variety of suitable foams exist, a preferred foam is a micro cell, closed cell Foam, such as that commercially available from Spongeex Corporation of Shelton, Connecticut, In particular, such foams with a thickness of between about 2.54 cm and about 5.08 cm (about 1 inch and about 2 inches) generally have sufficient compressibility to shield the underlying vehicle panel against the significant impacts.

Various considerations affect the selection of materials for the impact absorber cover or sleeve. In particular, colorfastness, heat resistance, mold inhibition qualities, and impermeability are among theses considerations. Suitable materials include Cordura® fabric, which is commercially available from Invista, Inc., of Wilmington Del.; polyester; Gore-Tex® fabric, which is commercially available from W. L. Gore & Associates, Inc., of Newark Del.; and acrylic fabric. Acrylic fabrics, such as Sunbrella® fabric, which is commercially available from Glen Raven Custom Fabrics, Inc., of Glen Raven, N.C., possesses superior resistance to extreme weather conditions. Preferably, the cover or sleeve shall be configured such that it may be opened and sealed at at least one end, so that the impact absorbing element may be removed. Removal of the impact absorbing element facilitates the cleaning, repair, or replacement of the sleeve or cover.

The non-abrasive portion of the cover may be chamois, nylon, silk, or a similar non-abrasive fabric. This portion of the cover is available to protect the finish of the vehicle against damage due to the interaction of the heated surface of the vehicle and the apparatus itself These covers may be available in colors that correspond to or contrast with the color of the vehicle's finish.

Alternatively, the covers may be made available in fanciful colors and patterns or may include, but not limited to, slogans, symbols, or trademarks for advertising purposes; corporate logos; personalized messages; safety notices or warnings; and names or service marks of professional and non-professional sports franchises, universities, high schools, or any other third party that wishes to supply a message or artistic rendering. These covers also may be removable, so that the covers may be repaired, replaced, or cleaned. Because the covers may be removable, a variety of different covers may be used interchangeably, so that a single apparatus may be used with a variety of vehicles or may display slogans, symbols, trademarks, names, service marks, messages, or the like that are appropriate or desirable for a particular season, occasion, event, or the like.

When mounting the impact absorber to the vehicle, a strap connecting the impact absorber to the vehicle was desirable to permit for height adjustments and to provide flexibility in the placement of the impact absorber. Such straps may be attached in a variety of ways. The straps could be looped around the vehicle's side view mirrors or fed over the weather stripping of the vehicle's door window and secured by the fiction of the door against the frame with a adjustable plastic connector inside connected to the strap or fed through a sliding door and attached to the clothes hooks available in many vehicles or secured with a magnet to the top of a vehicle. Alternatively, hooks affixed to suction cups, such as locking suction cups, are sufficiently secure to support the apparatus in many applications. In particular, locking suction hooks, such as those commercially available from Spectrum Diversified Designs, Inc., of Streetsboro, Ohio; InterDesign Inc., of Solon, Ohio; and Interlink Products International, Inc., of Linden, N.J.; may support the weight of the impact absorber and may be attached to the window or roof or another suitable vehicle panel of the vehicle. We tested these suction cups under extreme cold and heat by attaching them to the windows of vehicles during severe beat and cold temperatures. Such locking suction cups also may be attached to the front and rear vehicle panels, directly on the painted surfaces, to shield the vehicle bumpers without compromising the integrity of the vehicle's painted panels. Although such locking suction hooks are suitable in most normal weather conditions, other securing devices may be employed to secure the apparatus in high winds, when vehicles windows are icy, or to deter or prevent theft of the impact absorbers.

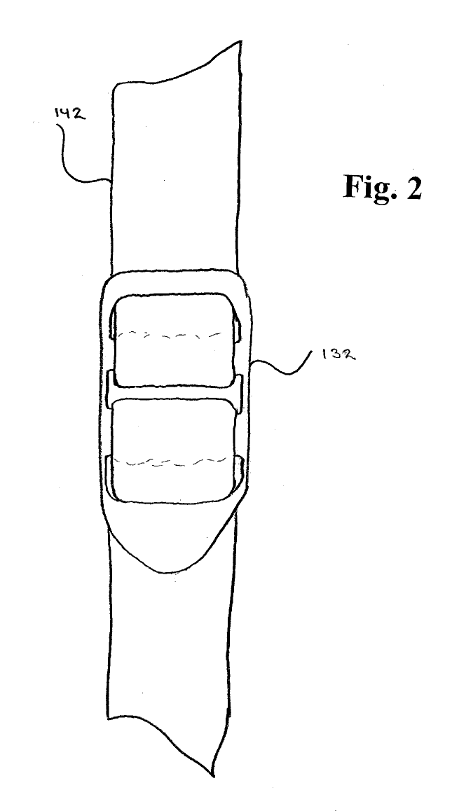

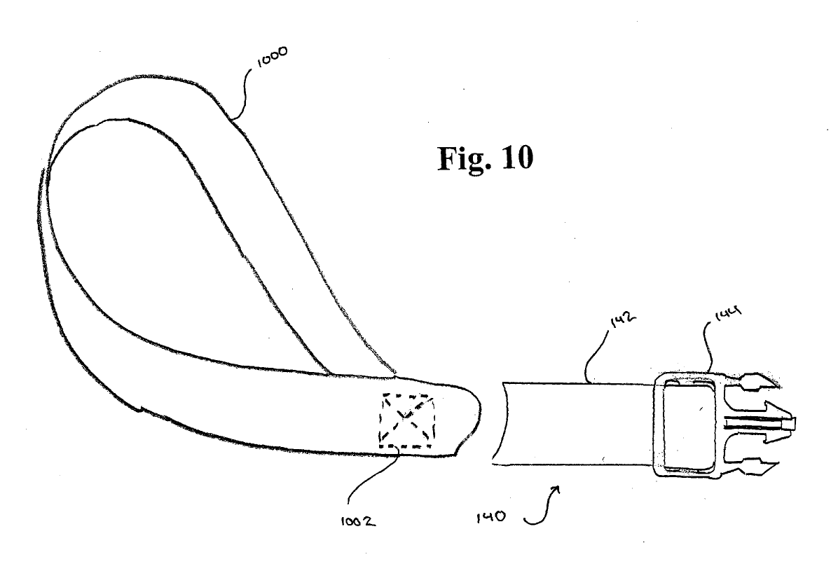

As noted above, FIG. 1 depicts an embodiment of the apparatus mounted by two mounting straps 130 to automobile 10. Straps 130 as the means for mounting may be thrown over the top of an automobile's door sill 14 and secured between an automobile's body 16 and a door frame 15. Straps 130 may be used to position impact absorber 110 generally over the areas of vehicle panels, e.g., door panels 12. An adjusting device 132, depicted in FIG. 2, may be positioned inside or outside of the automobile's door, If inside the door, the adjusted may act as a stop, thus preventing strap 130 from being drawn through the gap between automobile door frame 15 and body 16. Adjusting device 132 also may be positioned outside the automobile's door to facilitate adjustments to the position of impact absorber 110 with respect to the door panels 12. Alternatively, straps 130 may be secured between the window and door frame 15, or straps 130 may be secured around mirrors, floodlights, or other vehicle accessories, for example, by the embodiment described below with respect to FIGS. 10. By gently pulling on strap 130 once the door is closed, adjusting device 132 may be drawn towards or into contact with the inside of the automobile's door, and the apparatus, thus, may be secured in place.

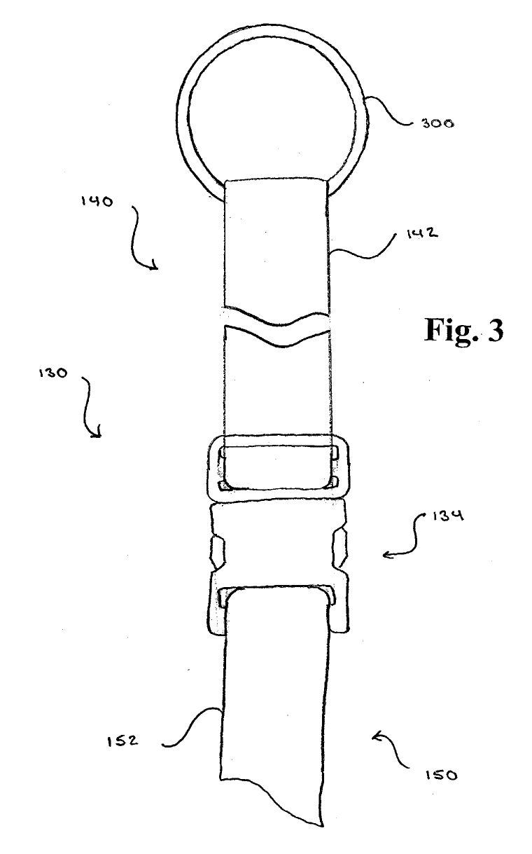

As noted above, FIG. 2 depicts adjusting device 132 suitable for use on mounting strap 130. Adjusting device 132 may be similar to that found on the many types of straps, e.g., nylon straps such as those of known backpacks. Adjusting devices 132 allow for lengthening or shortening the means for mounting. Once adjusted, adjusting device 132 may remain static unless the apparatus is moved to another size or type of vehicle. FIG. 3 may better depict a clasp 134 in that it shows that clasp 134 detaches between a first portion 152 and a second portions 140 of strap 130.

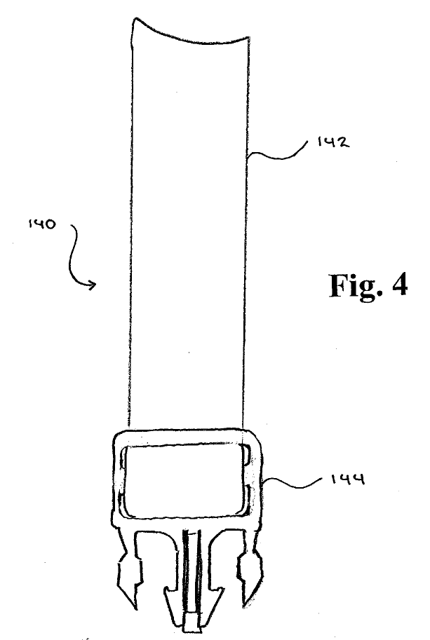

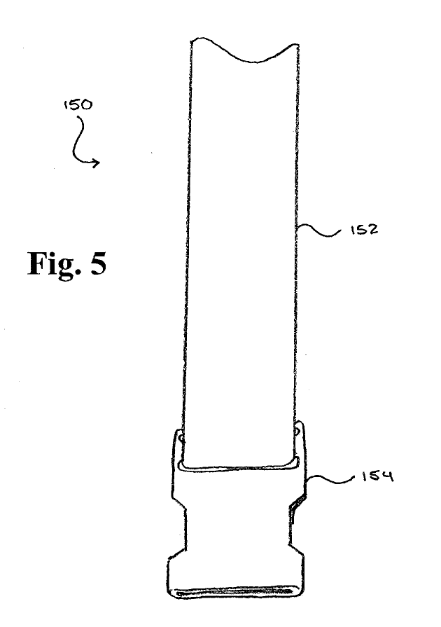

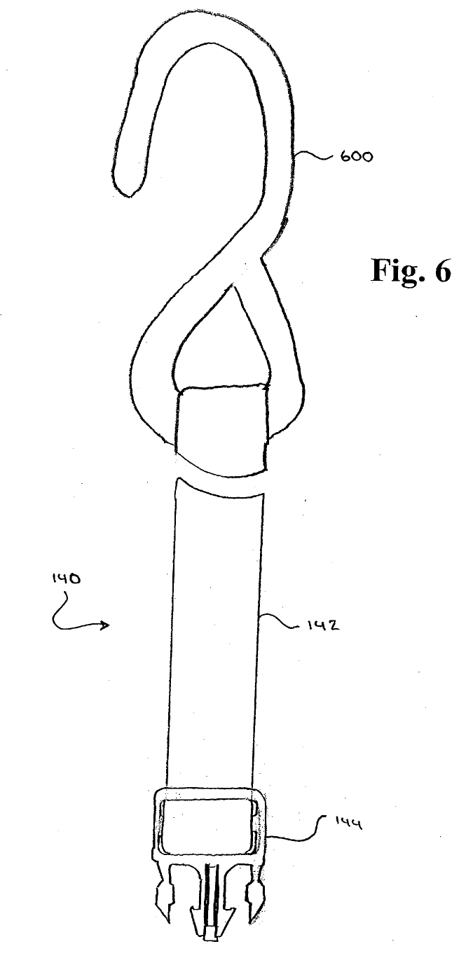

FIG. 3 depicts means for mounting comprising clasp 134 disposed between first portion 150 of strap 130 connecting to impact absorber 110 and second portion 140 of strap 130 comprising a ring 300, Ring 300 may be looped over a passenger compartment clothing hook (not shown) or other protrusion. If an automobile door is available to mount the apparatus, nothing else may be necessary as the apparatus may stay in place by the method described above. There are, however, other connecting mechanisms, described in FIGS. 6-10, which may be used interchangeably as part of the apparatus in view of the connecting and receiving devices described in FIGS. 4 and 5. These may be used for a variety of vehicles, but may be particularly useful for minivans, vans, and trucks. FIG. 4 depicts a connector portion 144 that is affixed to a connecting end 142 of second portion 140 of strap 130. FIG. 5 depicts a receiving portion 154 that is affixed to a connecting end 152 of first portion 150 of strap 130 that may be connected to impact absorber (not shown). Adjusting device 132, such as that depicted in FIG. 3, may be included on either on first portion 150 or second portion 140, or both of strap 130.

FIG. 4 depicts connecting or male portion 144 of clasp 134 that may be employed to add alternate second portions 140 of strap 130 and to permit use of the apparatus with different vehicles. In a preferred embodiment, adjusting device (not shown) may be disposed on second portion 140 of strap 130. Thus, FIGS. 4 and 5 provide greater detail of the type of clasp, clasp 134, that may be attached at connecting end 142 of alternate second portion 140. Connecting or male portion 144 of clasp 134 on connecting end 142 may plug into receiving or female end 154 of clasp 134 on connecting end 152, thus forming straps 130 of the apparatus.

FIG. 5 depicts receiving or female portion 154 of clasp 134 that may be employed to connect alternate second portions 140 of strap 130 and to permit use of the apparatus with different vehicles. Alternatively, the length of straps 130 may be adjusted in response to the height of the vehicle next to which the user parked.

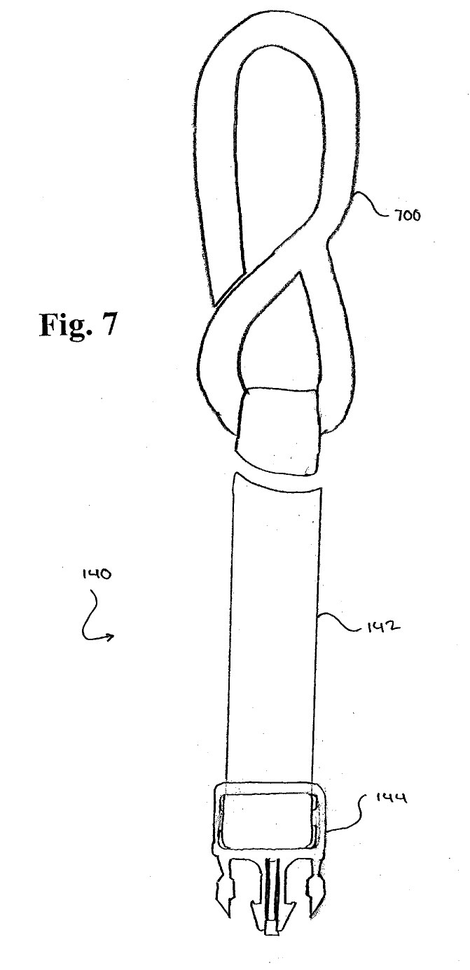

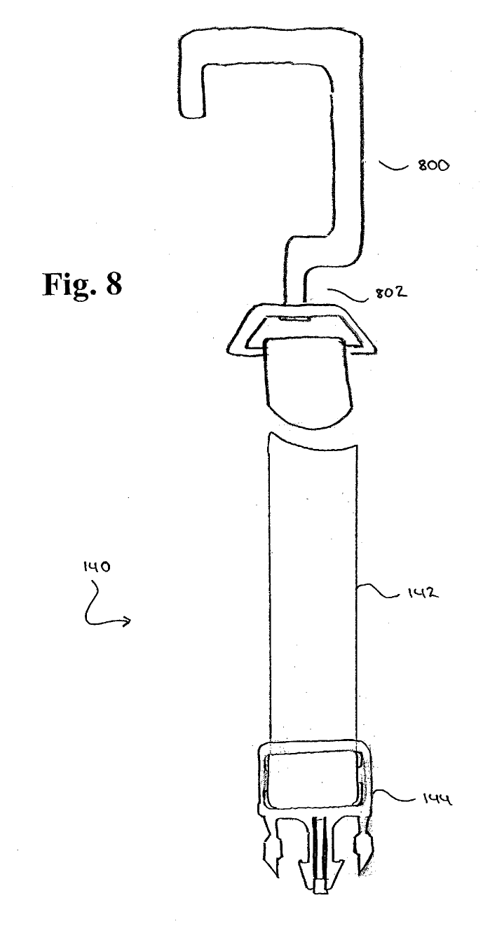

FIG. 6 depicts a hook suitable 600 for securing strap 130 to an eyelet or mounting ring (not shown) in a truck bed and second portion 140 of strap 130 including male portion 144 of clasp 134, as depicted in FIG. 4, FIG. 7 depicts an eyelet 700 suitable for securing strap 130 to a hook or handle (not shown), such as a clothes banger, inside the sliding door of a minivan and second portion 140 of strap 130 including male portion 144 of clasp 134, as depicted in FIG. 4. FIG. 8 depicts a rotatably mounted hanger 800 suitable for securing strap 130 to a roof rack (not shown) of a minivan, SUV, or the like and second portion 140 of strap 130 including male portion 144 of clasp 134, as depicted in FIG. 4. In FIG. 8, a rotational connector 802 supports hanger 800. As depicted in these figures, connector end 142 at the lower portion of the various second portions 140 are included as part of the means for mounting and, in particular, of strap 130.

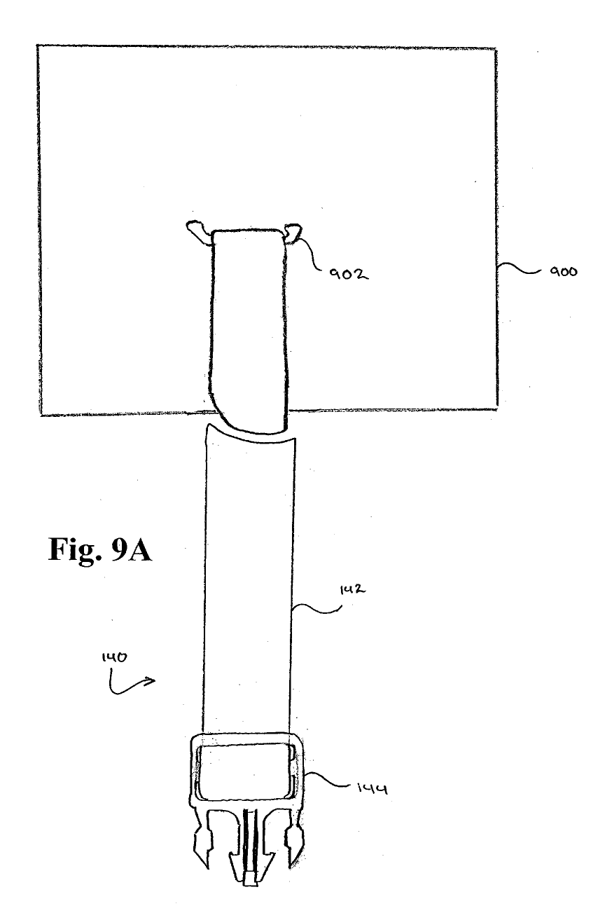

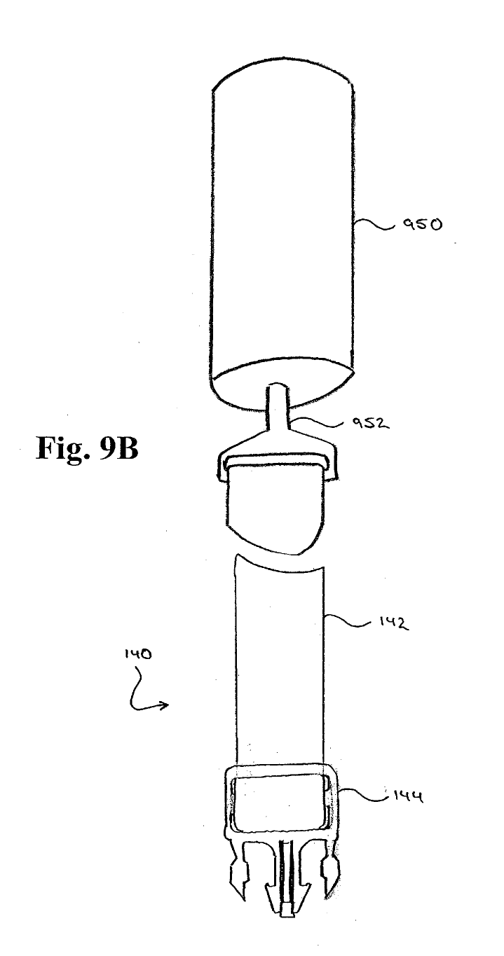

FIG. 9A depicts a substantially square magnet 900 affixed to strap 130, especially, a second portion 140 of strap 130, connected to and extending from one edge or a central portion, for use with certain vehicles including older van and truck models, which may not have a back door or roof rack from which to mount the apparatus. In particular, the magnet my comprise a connecting point 902 to which strap 130 may be secured. Magnet 900 may be shielded to prevent abrasions to the surface of a vehicle during attachment or removal. As noted above with respect to FIGS. 6-8, second portion 140 of strap 130 comprising male portion 144 of clasp 134, as depicted in FIG. 4, is shown. FIG. 9B depicts an alternative configuration of the magnet. In FIG. 9B, a substantially cylindrical magnet housing 950 is depicted with strap 130 coming off a mounting bracket 952 secured to one surface of housing 950, for use with certain vehicles including panel van or panel truck models, which may not have a back door or roof rack from which to mount the apparatus. Cylindrical housing 950 may be made from a non-abrasive polymer. Such a cylindrical housing or a housing of another three-dimensional geometric shape would be more readily positioned and removed from the vehicle than a flush-mounted magnet. A suitable cylinder may have a height of about 5 to about 7.5 centimeters (about 2 to about 3 inches) and a base diameter of about 2.5 centimeters (about 1 inch). Each of these depicted embodiments also comprises second portion 140 of strap 130 including male portion 144 of clasp 134, as depicted in FIG. 4.

FIG. 10 depicts a loop 1000 for securing second portion 140 to a vehicle's rear view or side mirror or a door handle or the like. As noted above, second portion 140 of strap 130 comprises male portion 144 of clasp 130, as depicted in FIG. 4. In further embodiments, loop 1000 may be padded or sheathed in a non-abrasive material to protect the portion of the vehicle about which it is secured. In addition, loop 1000 may be adjustable so that it may fit snugly over the portion of the vehicle about which it is secured. While each of the embodiments depicted in FIGS. 6-10 comprise male portion 144 on second portion 140 of strap 130, these embodiments may alternatively be configured to include female portion 154 on second portion 140 and a corresponding male portion 144 on first portion 150.

The apparatus also may be used to prevent rear bumper damage after parallel parking by throwing the straps into the trunk and pulling the taught as described above with respect to vehicle installation. With the front bumper, the apparatus may be manufactured from materials that possess a greater resistance to the effects of heat,

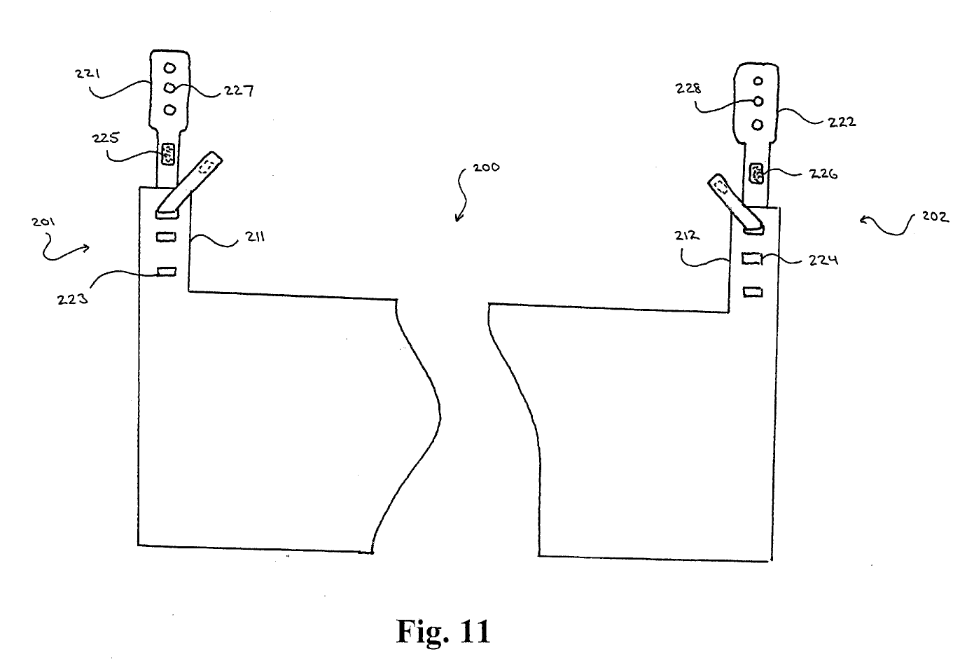

FIG. 11 depicts an apparatus 200 on which means for mounting 201 and 202 comprise a fist portion 211, 212 and a second portion 221, 222. First portions 211, 212 are fixedly attached to impact absorber 200, and second portions 221, 222 are attached removably and adjustable to first portions 211, 212, respectively. First portions 211, 212 further comprise a plurality of slots 223, 224 formed therethrough. Slots 211, 212 are configured to receive a first end of second portions 221, 222. Each of the first ends of second portions 221, 222 comprises a first fastener portion (shown by broken lines) which is configured to secure to a second fastener portion 225, 226. First and second fastener portions cooperate to form a fastener. Through the cooperation between slots 223, 224 and the fastener portions, the length of second portions 221, 222 may be adjusted to position impact absorber 200 over the desired vehicle panel. The fastener may comprise snaps; buttons and button holes; Velcro® fasteners, which are commercially available from Velcro USA, Inc., of Troy, Mich.; or the like, Second portions 221, 222 further comprise a plurality of hook receiving holes 227, 228, e.g., eyelets, formed therein for receiving a hook attached to the vehicle. Because each of second portions 221, 222 comprises a plurality of hook receiving holes 227, 228 the position of impact absorber 200 over the vehicle panels also may be adjusted by receiving the hook in a desired pair of selected hook receiving holes 227, 228. Thus, the position of impact absorber 200 may adjustable through the cooperation between slots 223, 224 and the fastener portions or through the selection of the appropriate hook receiving holes 227, 228, or both.

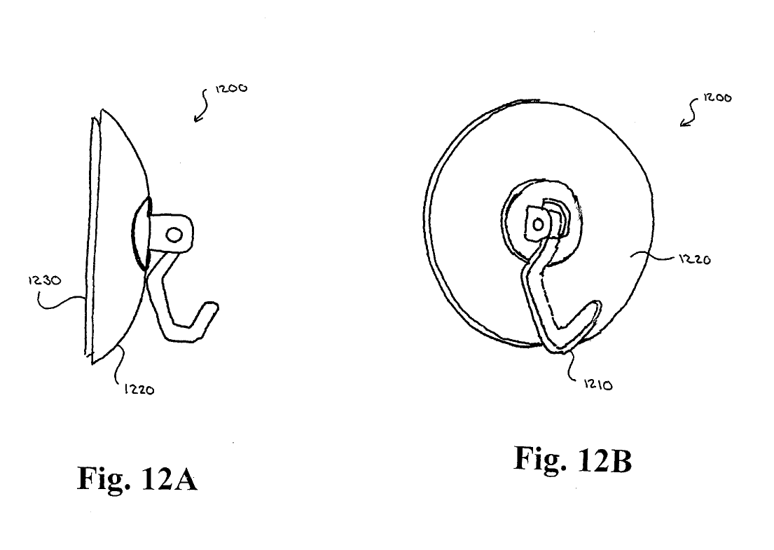

With respect to FIG. 11, impact absorber 200 may be mounted over a vehicle panel or panels by means of hooks that are permanently mounted on the vehicle, e.g., cargo hooks in a truck bed or on roof rack, or that are temporarily mounted on the vehicle, e.g., by magnets or suction cups. Referring to FIGS. 12A and 12B, a locking suction hook 1200 is depicted. Locking suction hook 1200 comprises a pivotable hook 1210 which may be configured to engage the suction cup to the vehicle when hook 1210 is pivoted into position to be received by hook receiving holes 227, 228. Locking suction hooks 1200 also comprise a cover 1220 to protect suction cup 1230 when secured to a vehicle. Suitable locking suction hooks, such as those commercially available from Spectrum Diversified Designs, Inc., of Streetsboro, Ohio; InterDesign Inc., of Solon, Ohio; and Interlink Products International, Inc., of Linden, N.J.; may support the weight of the impact absorber and may be attached to the window or roof or another suitable vehicle panel of the vehicle.

Although preferred embodiments of the present invention have been described in detail herein, the scope of the invention is not limited thereto. It will be appreciated by those of ordinary skill in the relevant aft that various modifications may be made without departing from the scope of the invention. Accordingly, the embodiments disclosed herein are only exemplary.

It is to be understood that the scope of the invention is not to be limited thereby, but is to be determined by the claims which follow.

What is claimed is:

1. An apparatus for temporarily shielding at least one vehicle panel against impact or abrasion, comprising an impact absorber, a non-abrasive cover disposed between said impact absorber and said at least one vehicle panel, and means for mounting said impact absorber to said at least one vehicle panel.

2. The apparatus of claim 1, wherein said at least one vehicle panel is selected from the group consisting of a door panel, a side panel, a fender, a trunk, a hood, a bumper, and combinations thereof.

3. The apparatus of claim 1, wherein said impact absorber is rectangular.

4. The apparatus of claim 1, wherein a length of said impact absorber is about 127 cm.

5. The apparatus of claim 1, wherein a width of said impact absorber is in a range of about 25.4 cm to about 40.8 cm.

6. The apparatus of claim 1, wherein said impact absorber comprises a plurality of impact absorbing elements.

7. The apparatus of claim 1, wherein said impact absorber comprises a plurality of layers of impact absorbing elements.

8. The apparatus of claim 1, wherein said impact absorber comprises a plurality of compartments, into each of which at least one impact absorbing element may be inserted to increase a width or a coverage area, or both, of said impact absorber.

9. The apparatus of claim 1, wherein said impact absorber is comprised of foam rubber.

10. The apparatus of claim 1, wherein said cover encloses said impact absorber.

11. The apparatus of claim 10, wherein said cover is made of a water resistant material.

12. The apparatus of claim 10, wherein at least an exposed surface of said cover is made of a water resistant material.

13. The apparatus of claim 1, wherein said means for mounting comprises at least one strap for securing said impact absorber to said vehicle.

14. The apparatus of claim 13, wherein said at least one strap further comprises a device for adjusting a length of said at least one strap.

15. The apparatus of claim 13, wherein said at least one strap further comprises a clasp, a first portion, and a second portion whereby said clasp is configured to separate said second portion from said first portion.

16. The apparatus of claim 13, wherein said at least one strap farther comprises a hook affixed to an end of each of said at least one strap, whereby said at least one strap is configured to be secured to said vehicle.

17. The apparatus of claim 13, wherein said at least one strap further comprises an eyelet affixed to an end of each of said at least one strap, whereby said at least one strap is configured to be secured to said vehicle.

18. The apparatus of claim 13, wherein said at least one strap further comprises a hanger affixed to an end of each of said at least one strap, whereby said at least one strap is configured to be secured to said vehicle.

19. The apparatus of claim 13, wherein said at least one strap further comprises a plurality of eyelets formed through an end of said at least one strap, whereby said at least one strap is configured to receive a locking suction hook, which is temporarily secured to the vehicle.

20. The apparatus of claim 18, wherein said hanger is rotatably affixed to said end of each of said at least one strap.

21. The apparatus of claim 13, wherein said means for mounting further comprises at least one magnet.

22. The apparatus of claim 1, wherein said means for mounting comprises at least one magnet.

23. The apparatus of claim 22, wherein said at least one magnet is disposed on a surface of said impact absorber facing said at least one vehicle panel.

24. The apparatus of claim 22, wherein said at least one magnet is disposed within said impact absorber.

25. The apparatus of claim 22, wherein said at least one magnet is affixed to said cover.

26. A kit for temporarily shielding at least one vehicle panel against impact or abrasion, comprising an impact absorber, a non-abrasive cover disposed between said impact absorber and said at least one vehicle panel and means for mounting said impact absorber to said at least one vehicle panel, wherein said means for mounting comprises at least one strap comprising a clasp, a first portion for positioning said impact absorber, and a plurality of interchangeable second portions.

27. The kit of claim 26, wherein said at least one strap further comprises a device for adjusting a length of said at least one strap.

28. The kit of claim 26, wherein a first securing device of said plurality of interchangeable second portions comprises a hook affixed to an end of said first securing device, whereby said first securing device is configured to be secured to said vehicle.

29. The kit of claim 26, wherein a second securing device of said plurality of interchangeable second portions comprises an eyelet affixed to an end of said second securing device, whereby said second se device is configured to be secured to said vehicle.

30. The kit of claim 26, wherein a third securing device of said plurality of interchangeable second portions comprises a hanger affixed to au end of said third securing device, whereby said third securing device is configured to be secured to said vehicle.

31. The kit of claim 26, wherein a fourth securing device of said plurality of interchangeable second portions comprises a locking suction hook, which is temporarily secured to the vehicle and a plurality of eyelets formed through an end of said third securing device, whereby said third securing device is configured to receive said locking suction hook.
